(19) United States
(12) Patent Application Publication
(10) Pub. No.: US 2008/0065476 A1
(43) Pub. Date: Mar. 13, 2008

(54) Online direct marketing system

(75) Inventors: Mark Klein, New Castle, NH (US); Brian Jenkins, Portsmouth, NH (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Loyalty Builders, Inc., Portsmouth, NH (US)

(21) Appl. No.: 11/517,175

(22) Filed: Sep. 7, 2006

(51) Int. Cl. G06Q 30/00

(52) U.S. Cl. 705/14

(57) ABSTRACT

An automated, unified, interactive system and methods for marketing. After a Marketer uploads transaction and customer data, the system automatically analyzes this data to predict at least one of the group consisting of purchase probabilities, likely buyers, up-sell opportunities, cross-sell opportunities, and potential defectors; selects a marketing campaign and customers to target in that marketing campaign, the step of selecting customers being based upon results from the step of analyzing customer and transaction data; predicts anticipated response rate and/or revenue from the marketing campaign; delivers at least one list of the customers to target, wherein the list of customers further comprises customer records; supplies an expert system to test elements of the campaigns such as targeting and offers; and collects fees based on a number of the records downloaded.

### RELATED APPLICATION(S)

This application is related to U.S. Patent Applications Attorney Docket No. 4081.1001-000 entitled “Predicting Response Rate” filed on Sep. 7, 2006 and Attorney Docket No. 4081.1002-000 entitled “Factorial Design Expert System” filed on Sep. 7, 2006. The entire teachings of the above application(s) are incorporated herein by reference.

### BACKGROUND OF THE INVENTION

Marketing is the process through which a company induces new and existing customers to buy its products and services. One familiar type of a marketing activity is advertising, where a company broadcasts its message to whomever is viewing the medium carrying the advertising message, for example newspapers, television, billboards, web sites, even the sides of buses. Another type of marketing activity is direct marketing, in which a company tries to address its prospects and customers individually through postal mail or email.

Key direct marketing activities include segmentation, targeting, testing, campaigning, and measuring. Segmentation is the process of ranking customers according to their value to the company or by their propensity to buy again. Targeting is the process of selecting potential buyers, perhaps for particular products or their likelihood of making a purchase in the near future or because they may be in danger of defecting, among other reasons. Properly done, targeting should also include predicting the results of the actual campaign. Testing is the process of experimenting to determine the most effective offers or the right customers to target. Campaigning involves contacting the targeted customers by appropriate media such as email or direct mail. Finally, the transaction behavior of the targeted customers is measured to determine the effectiveness of the campaign and the Return on Investment (ROI) made to realize the sales.

While each of these activities is well understood, each can present formidable challenges, especially for small and mid-sized companies with limited staff and budget. Some of the biggest obstacles include:
No one source for services, forcing marketers to multiple departments or external vendors, making the process of launching a campaign complex, time consuming, and expensive
Finding staff with the necessary multi-discipline skills; smaller companies especially lack people with database, analytical, and statistical expertise, and marketers often don't have these required skills themselves
Designing experiments to test marketing variables, including maintaining clean controls; marketers without mathematical expertise often skip this step at great cost to their company because of its complexity or because of a lack of understanding of proper experiment design
Estimating response rate or revenue before launch; without good estimates it is very difficult to create cost-effective campaigns
Size of the customer base or the number of products create computational problems when calculating the likelihood of each customer purchasing each product

Many companies supply some of the necessary services. However, there is no complete, end-to-end solution simple enough to be used by less experienced marketers.

Enterprise-sized companies have been using technology to manage marketing activities for several years, but smaller companies have neither the staff nor the expertise (and sometimes not the funds) to replicate the technology-based solutions used by their larger competitors, as much as they would like to do so. There is a need in the marketplace for an easy-to-use yet comprehensive system that overcomes the obstacles listed above.

### SUMMARY OF THE INVENTION

The present invention provides an automated, unified, interactive system and method for marketing to existing customers. The method can include the following steps: uploading transaction and customer data; analyzing this data to predict at least one of the group consisting of purchase probabilities, likely buyers, up-sell opportunities, cross-sell opportunities, and potential defectors; selecting a type of marketing campaign and customers to target in that marketing campaign, the step of selecting customers being based upon results from the step of analyzing customer and transaction data; predicting anticipated response rate and/or revenue from the marketing campaign; delivering at least one list of the customers to target, wherein the list of customers further comprises customer records; and collecting fees from a user based on a number of the records downloaded by the user.

A number of additional and/or optional steps may also be carried out, including but not limited to testing campaigns, reporting campaign results, and account management as more fully explained in the detailed description below.

In a preferred embodiment, the automated system is implemented as a set of Web servers; a set of database servers that manage transaction data and predictive analytics results for clients of the system; a set of analysis servers that analyze the transaction data and predict purchase probabilities; a data storage that serves data to and receives data from the servers of the system; a job queue that organizes and prioritizes a set of tasks necessary to operate the system; and a controller that executes the set of tasks in the job queue in a time-efficient manner.

The invention has a number of advantages over previously disjointed, cumbersome or expensive direct marketing systems and/or software applications.

Targeting of customers is improved, as the automated system provides increased accuracy as a result of predictive analytics. Automated generation of control groups also allows for more effective testing of campaigns.

The business owner or marketing specialist need not be concerned with the mathematical complexity of predictive analytics, which are embedded in one or more analysis servers. The typical user needs only to be concerned with elements that are familiar to any business owner or marketer, such as supplying data concerning customers and proposed marketing campaigns,

Costs are also confined, a particularly important consideration for businesses of all sizes. A business not longer needs to purchase or license a suite of expensive business marketing software applications; rather, the costs are directly related to the number of customer records downloaded.

The system also permits the user to identify up-sell and cross-sell opportunities, calculate purchase probabilities for every customer and every product, and find potential defectors.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a system level diagram illustrating the components of a system that uses an Online Direct Marketing System (ODMS) according to the invention.

FIG. 2 is a flow diagram illustrating one possible interactive process between the ODMS, a Marketer, and the Marketer's Customers.

FIG. 3 is block diagram of the integrated functions provided by the ODMS.

FIG. 4 is a more detailed of the ODMS and internal data flows.

FIG. 5 is an example of a data upload input screen.

FIG. 6 is an example control group setup screen.

FIG. 7 is an example email campaign setup screen.

FIG. 8 is an example campaign name and service selection input screen.

FIG. 9 is an example choosing product(s) input screen.

FIG. 10 is an example probability range input screen.

FIG. 11 is an example selecting groups of customers screen.

FIG. 12 is an example set calendar options screen.

FIG. 13 is an example predicting campaign response screen.

FIG. 14 is an example dashboard metrics input screen.

### DETAILED DESCRIPTION OF THE INVENTION

A description of preferred embodiments of the invention follows.

The present invention is a direct marketing system that overcomes the obstacles faced by marketers who do not have the resources often available to their counterparts in larger corporations. The system operates over the Internet, and hence is described as an Online Direct Marketing System (ODMS), but the marketing activities and campaigns it creates can be deployed over several medium including print, facsimile, telephone, and email.

A. Overview of System Architecture and Automated Direct Marketing Process

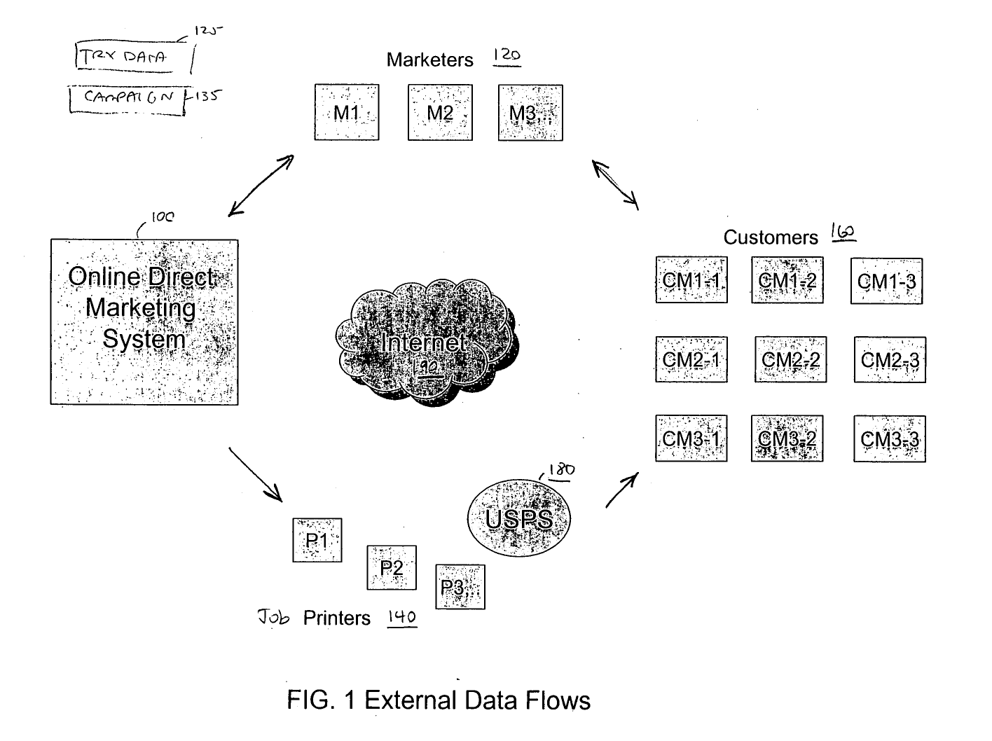

FIG. 1 shows the several entities that interact, directly or indirectly, with the ODMS 100. These include Marketers 120 (individually referenced as M1, M2, M3, . . . in the figure); Job Printers 140 (P1, P2, . . . ); and Customers 160 (CM1-1, CM1-2, . . . ). Marketers 120 use the ODMS 100 to create and execute the campaigns. Customers 160 are the customers of the products or services offered by Marketers 120 (directly or indirectly). Customers 160 are individually denoted by CMx-y, where x references Marketer x, and y is the customer number. Job Printers 140 produce and mail collateral to Customers 160, such as by using the U.S. Postal Service 180 (USPS).

In general, an automated direct marketing campaign process according to the invention involves the Marketers 120 uploading transaction data (TRX) concerning past transactions with Customers 160 to the OMDS 100. The Marketers use the ODMS 100 to interactively design and test campaigns, based on analytics derived from the transaction data within the ODMS 100. A campaign is then selected within the ODMS 100, which then can be downloaded to the marketer's own system or automatically executed, such as by sending instructions to Job Printers 140. Most but not all communications between these entities happen over the Internet 190, shown as a cloud in the center of FIG. 1. While only a few instances of each entity are shown in FIG. 1, it should be understood that the ODMS 100 can accommodate anywhere from a few to many, many instances of each type of marketers 120, printers 140 and customers 160. As described in more detail below, elements of the system are implemented in database and software application servers, and thus the system is easily scaled to accommodate demand.

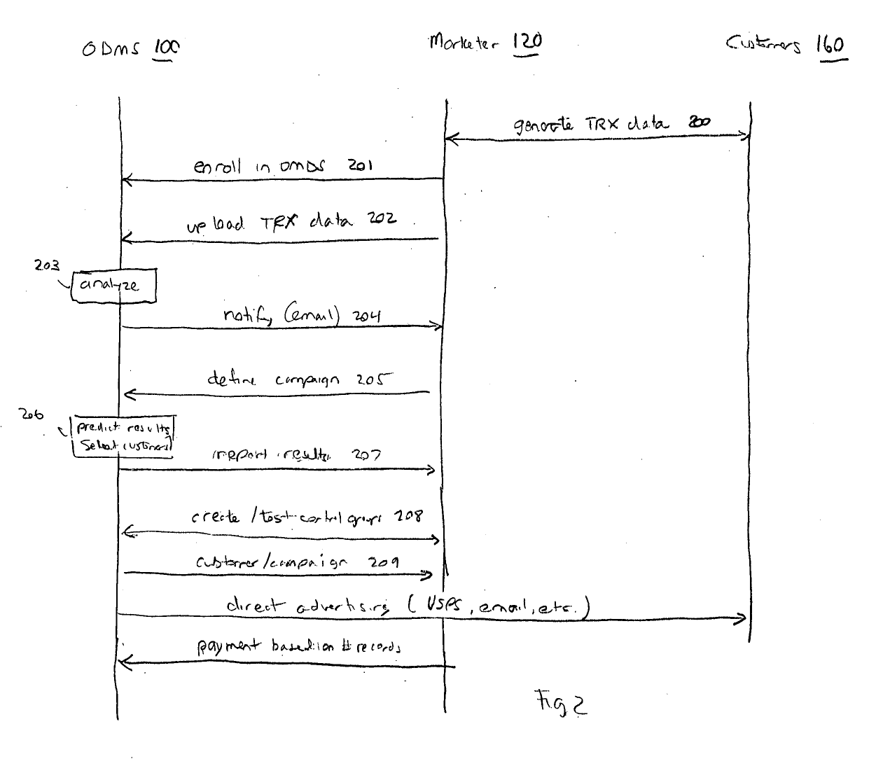

These processes are shown in more detail in FIG. 2, which illustrates a typical step-by-step process for one way in which the system operates. The process proceeds as follows (continue referring to FIG. 1 for system element configuration):

Step 201. A Marketer 120 enrolls via Internet 190 to use the Online Direct Marketing System (ODMS) 100, such as by using a web client (browser) based enrollment dialog.

Step 202. Marketer 120 then sends transaction data 125 (TRX) via Internet 190 to the ODMS 100. Transaction data was generated at some previous time (in step 200) via interactions between customers 106 and marketer 120.

Step 203. The ODMS 100 then analyzes the TRX data 125.

Step 204. The ODMS 100 optionally notifies Marketer 120, such as via email, of the availability of analysis results.

Step 205. The Marketer 120 again uses web client (browser) to interact with the ODMS 100 and define a campaign 135.

Step 206. The ODMS 100 predicts results of the campaign 135 and selects appropriate Customers 160.

Step 207. The ODMS reports via web client the predicted results and customers who are targeted.

Step 208. Optionally, the Marketer 120 uses a Testing facility within ODMS 100 to create control groups of customers to test targeting or offer effectiveness, and receive results of such tests.

Step 209. Marketer 120 either downloads customer records and campaigns for selected customers, or

Step 210. Optionally, the ODMS 100 interacts with Marketer and then sends Marketer-designed emails via Internet, direct mail via USPS, or other targeted promotions to Customers 160.

Step 211. Marketer 120 pays ODMS 100 for services based on number of records selected and emails sent or printed materials mailed.

Step 212. At conclusion of campaign, Marketer 120 sends latest TRX data to ODMS 100.

Step 213. Via email, or at request via web client by Marketer 120, ODMS calculates campaign effectiveness and Return on Marketing Investment. This can be determined by, for example, subtracting from the gross margin contribution of responding customers the several charges associated with selecting customers to target and generating email or direct mail to them.

B. Automated Functions Provided by the ODMS

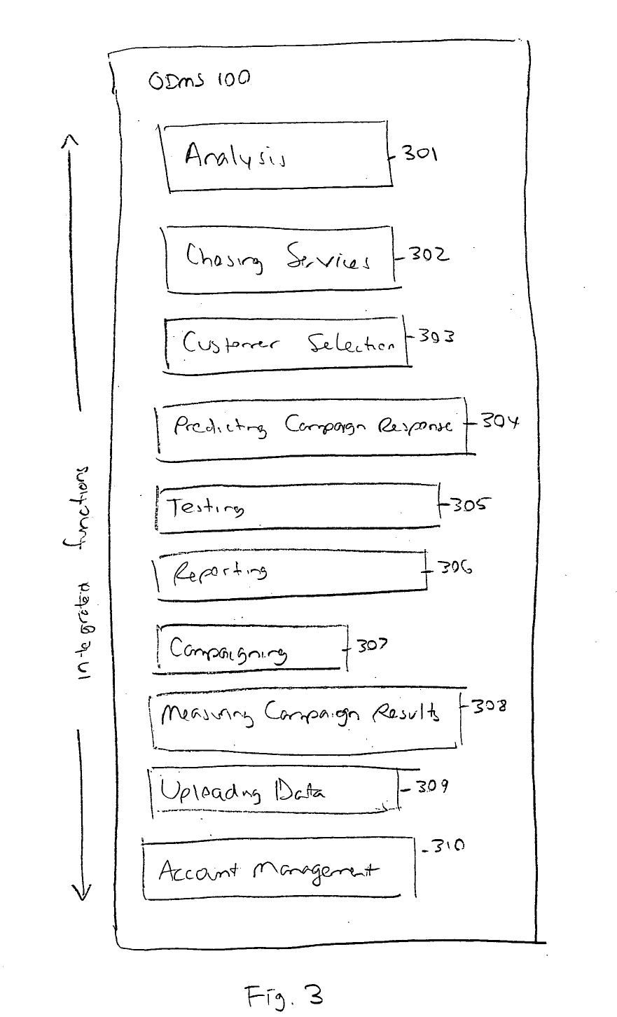

In order to enable this set of processes in an automated, integrated, direct marketing system, the ODMS 100 preferably includes a number of software functional elements. FIG. 3 is a high level diagram illustrating key functions performed by the ODMS that can be used in support of the proceses of FIG. 2. These include but are not limited to Anaylsis 301, Chosing Services 302, Customer Selection 303, Predicting Campaign Response 304, Testing 505, Reporting 306, Campaigning 307, Measuring Campaign Results 308, Uploading Data 309, and Account Management 310. A typical implementation of each of these functions is now described, with the understanding that a functioning system need not implement all of the indicated functions in the same way, or with all of the listed features.

Analysis 301—Underlying the ODMS 100 is some software based system to predict customer behavior. The methodology for that system can be any one of several mathematical methods well known to those reasonably skilled in this area, including but not limited to RFM, regression, genetic algorithms, neural nets, or finite state machines. The analysis system uses the inputs described below and produces scores for each Customer 160 that are typically stored on a database server.

Choosing Services 302—Some marketing services that a typical ODMS 100 could handle are

Up-sell—offering to Customers 160 more of the products or services that they have previously purchased

Cross-sell—offering Customers 160 products or services that they have not previously purchased

Likely buyers—Customers 160 predicted to make some kind of purchase in the near future

Early warning system—identifying Customers 160 whose buying behavior is deteriorating

Selecting customers to target 303—an ODMS 100 takes answers provided by Marketer 120 to questions about existing Customer 160 behaviors and attitudes that are contained in the database, and uses this information to build a set of Customers 160 matching the constructed profile. Some typical parameters used in building the profile include but are not limited to

Segmentation score—Customers 160 may be ranked by any of several methods, for example RFM scoring, genetic algorithms, or loyalty scoring. After scoring the customers, they can be further segmented by deciles, and the Marketer 120 could specify which deciles to include in the profile.

Purchase probabilities—The ODMS 100 may have data describing the probabilities for each of the Customers 160 to buy each of the goods or services offered by the Marketer's 120 company. The profile could put boundary conditions, maxima and minima, around probabilities so as to only include customers whose purchase probabilities fall within the specified range.

Featured products—Marketers 120 may be given the opportunity to select which products or services will be offered, so that the profile can select Customers 160 with a propensity to buy those products or services.

Recency—Recency is a measure of the elapsed time since a Customers' 160 previous purchase. Marketers 120 use a parameter like this to, for example, exclude or include Customers 160 who have made a recent purchase or who have not purchased in such a long time as to render them “inactive”.

Frequency—This measure of a customer's rate of purchasing is a commonly used metric to profile Customers 160.

Revenue to date—Many companies segment, score, or profile Customers 160 based on the total money spent by the customer over some period of time.

Types of customers—Marketers 120 often profile Customers 160 based on their preferred purchasing channel (for example mail order, internet, store, etc.) or distribution channel (wholesale or retail) or by geography.

Campaign start and end dates—Probabilities have expiration dates and Customers 160 have natural buying cycles, so it is often important to match the buying cycles with the planned campaign dates.

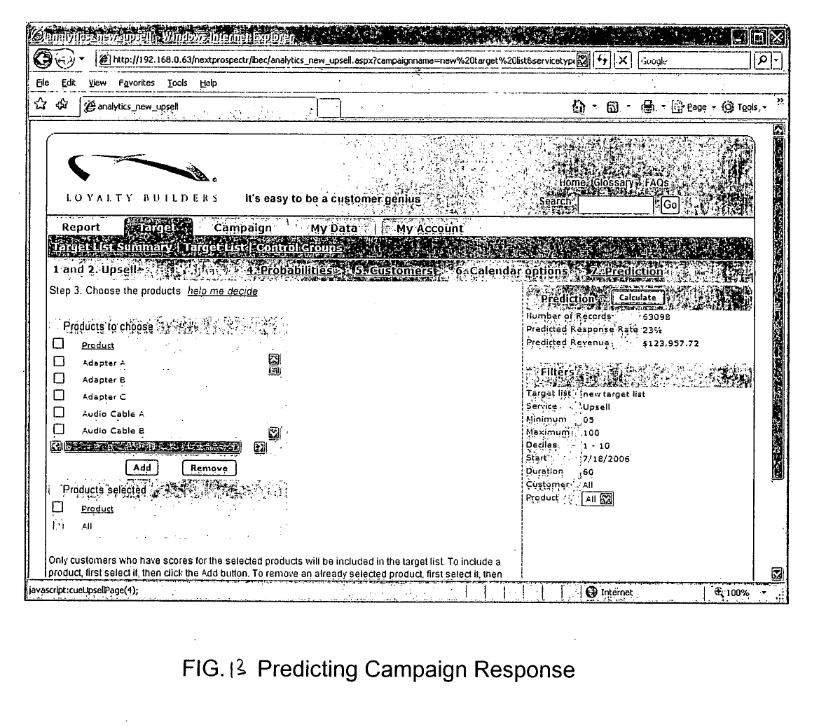

Predicting campaign response 304—An important component of the ODMS 100 is a method for predicting the response rate of the targeted Customers 160, so that the Marketer 120 can determine if the constructed profile is likely to yield a profitable campaign. Predictions can range from a gross approximation based solely on previous revenue from the selected Customers 160 to a much more granular approach based on small subsets of Customers 160, as described in the above referenced patent application entitled “Predicting Response Rate”. FIG. 13 herein shows one example of how this type of prediction can be displayed and used by Marketer 120.

Testing 305—Being able to test targeting and offers is an important component of successful marketing campaigns. The ODMS 100 includes this capability as an optional activity.

Choosing control groups—In order to test properly, the ODMS 100 should assist the Marketer 120 in setting up the groups and assigning treatments to each subgroup. Preferably the Marketer 120 should only have to specify the number and type of factors to test, plus the size of the population to use for the test. An expert system should assign users to appropriate groups.

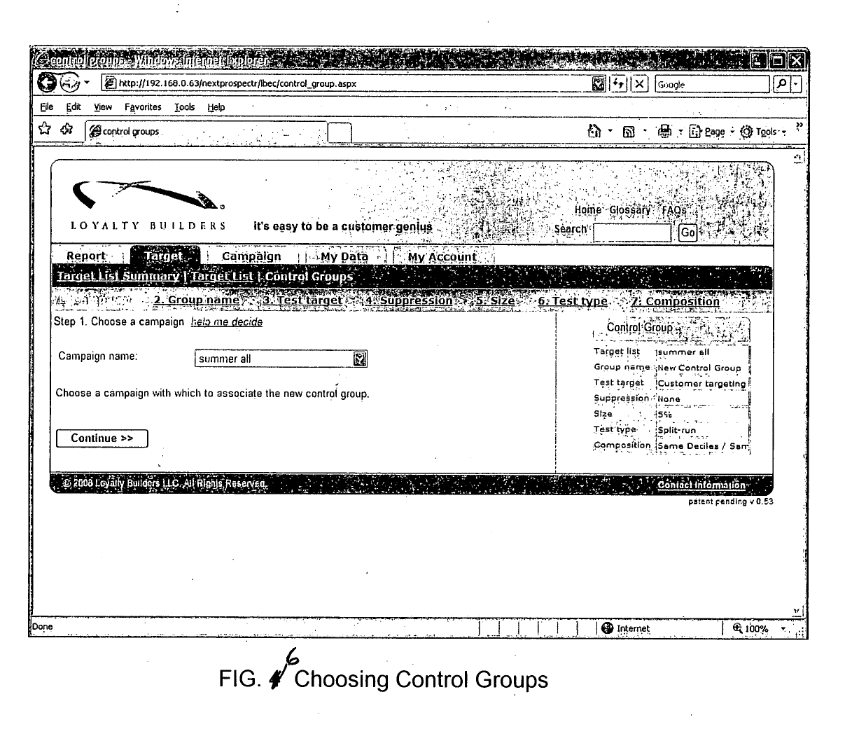

FIG. 6 is a screen shot from one embodiment of the invention showing the steps in choosing control groups.

Measuring testing results—The ODMS 100 applies standard algorithms to determine which treatments are most successful and which ones to ignore. Regardless of the number of factors tested, the ODMS will examine the transaction behavior of the targeted Customers 160 at a date soon after the end of the tests to determine which targeted Customers 160 purchased and/or which offers were effective. In one exemplary embodiment of the ODMS 100, Factorial Design Methodology is used to set up testing recipes and calculate testing results, as described in the pending application entitled “Factorial Design Expert System” as referenced above.

Reporting 306—The ODMS 100 needs to communicate to the Marketer 120 what has transpired and what has been learned. Specifically, Marketer 120s need to investigate:

Customer analytics—Both summary and account level data should be available.

Key indicators—Many key business parameters can be calculated from the transaction data in the ODMS 100, for comparison with the same information obtained from other sources.

Testing results—This functionality reports on the results of the marketing tests.

Campaigning 307—The purpose of an ODMS 100 is to conduct marketing campaigns, so a facility to actually launch and measure the campaigns is included. One or more campaign design input screen(s) permit the user to define a campaign. These can include input screens for choosing:

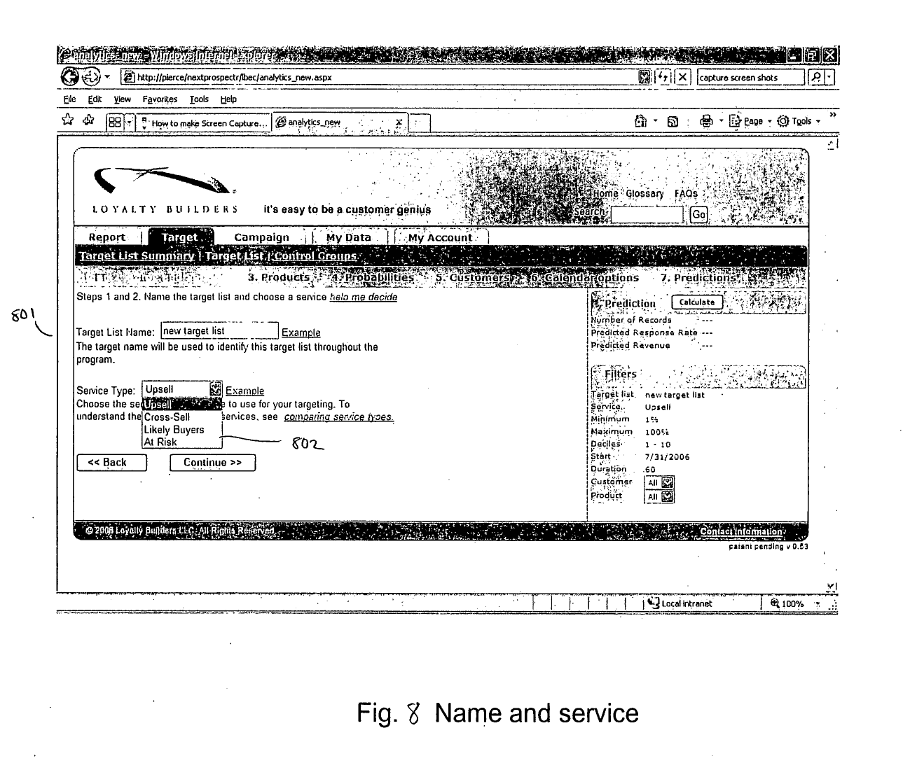

a name for the marketing campaign (e.g., target list name text box 801) as in FIG. 8;

a type of service, where service choices might include up-sell, cross-sell, likely buyers; or customers at risk of defecting (e.g., drop down list 801) as in FIG. 8;

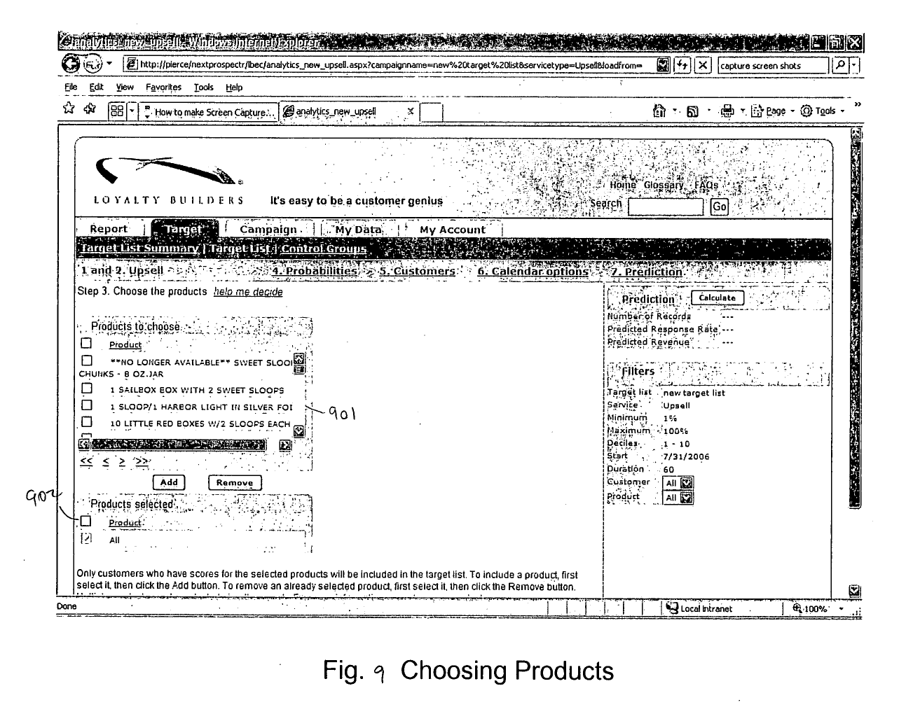

products to sell in up-sell or cross-sell campaigns (e.g., scroll list 901 and check box 902) as shown in FIG. 9;

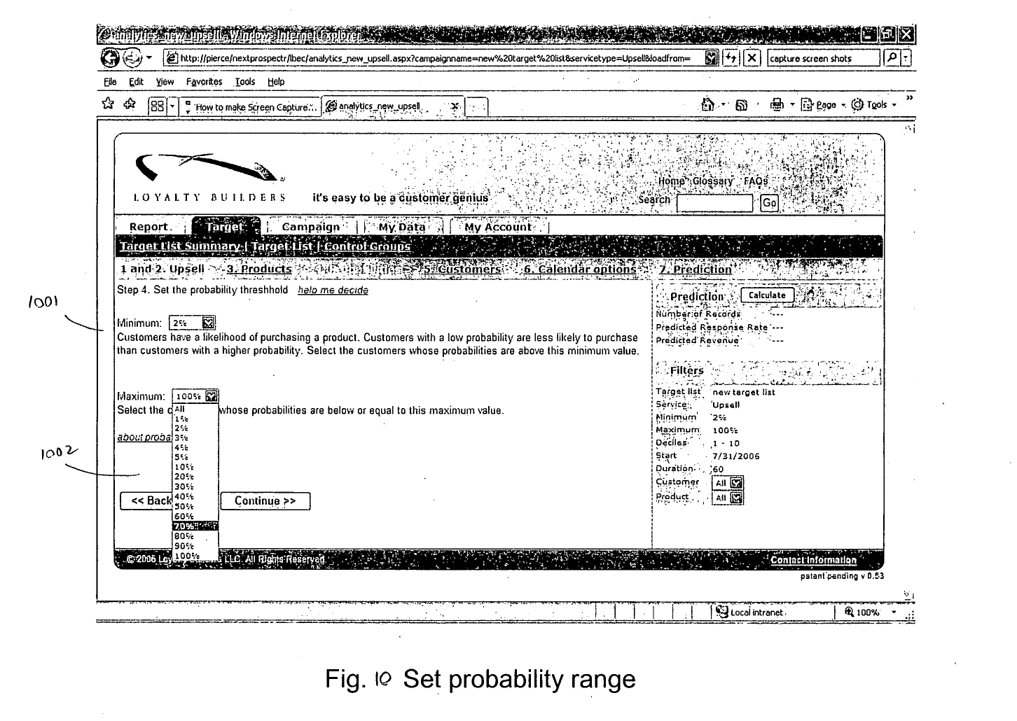

a purchase probability range (so that targeted customers fall within the range (e.g., minimum 1001 and maximum 1002 drop down lists/input boxes) as in FIG. 10;

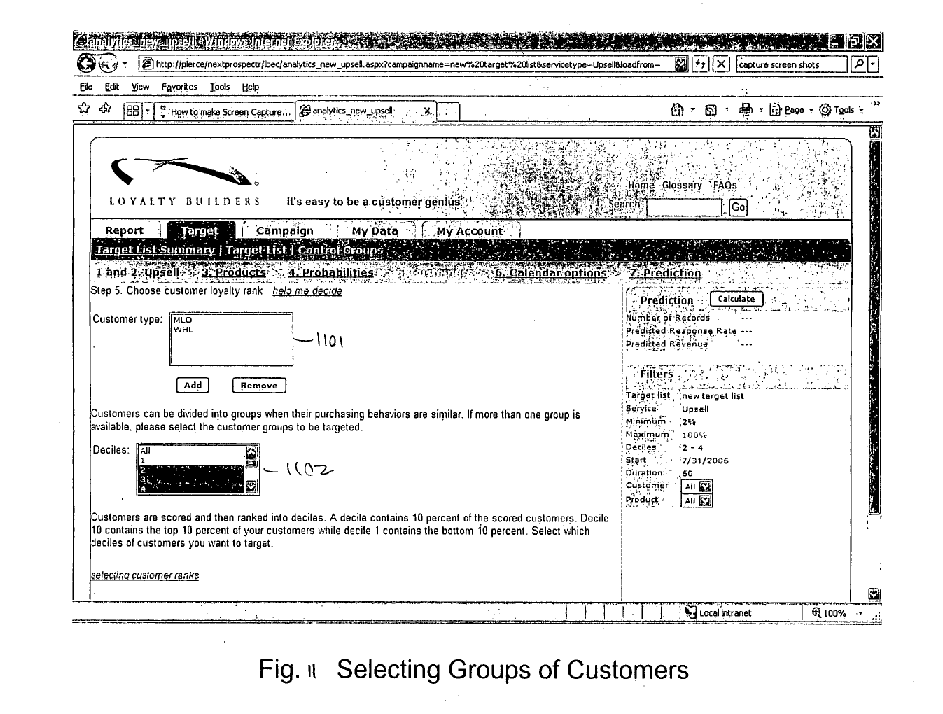

whether to select or suppress certain subgroups of customers such as high or low ranking customers or customers in a particular marketing channel as in FIG. 11 (e.g., to select only customers of a certain type 1101 and decile rank 1102);

whether to select or suppress individual customers based on any or all of several other marketing metrics; and

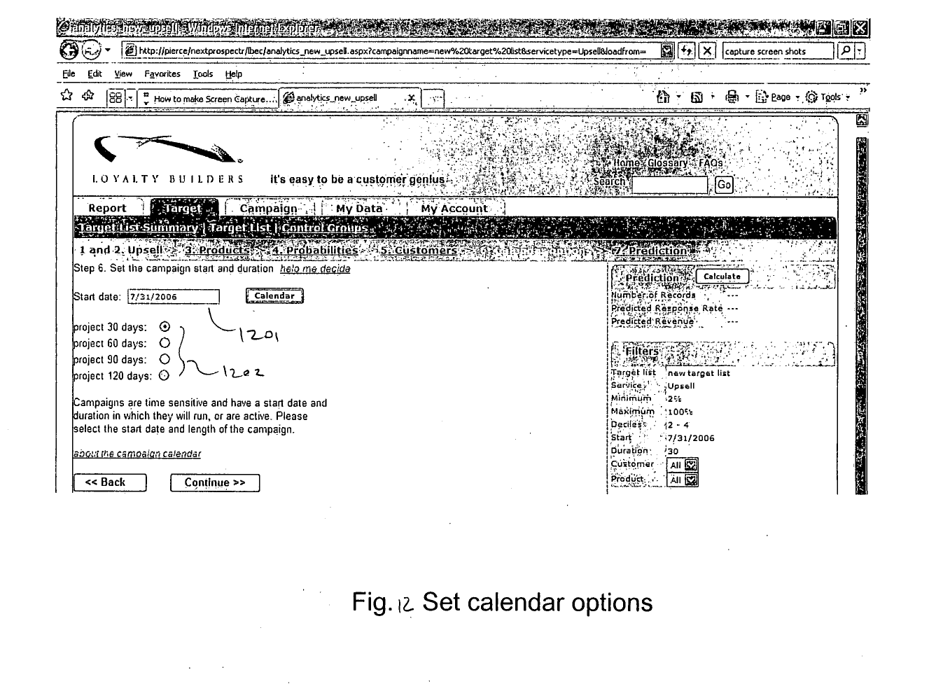

a start date and duration for the marketing campaign so as to select customers whose metrics match the desired criteria during the campaign interval (e.g., the date range input box 1201 and project radio buttons 1202) as shown in FIG. 12.

Two types of campaigns are supported in a typical exemplary implementation, although other types of direct promotion delivery are possible.

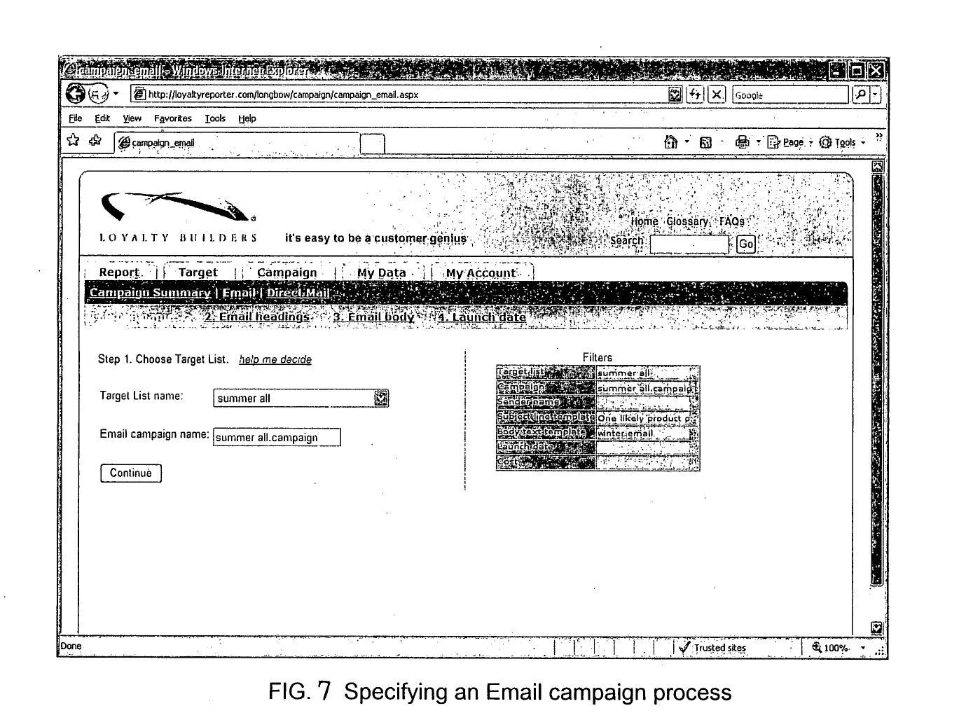

Email campaigns—The ODMS 100 launches emails on behalf of the Marketer 120 to the targeted Customers 160. Typical inputs, as show in in FIG. 7, specify an email body copy from a set of preset or custom templates, target recipient list, campaign name, sender name, launch date and cost parameters.

Direct mail campaigns—The ODMS 100 ships lists of targeted Customers 160 and associated collateral to associated printers. The printing firms in turn create and send direct mail on behalf of the Marketer 120.

Measuring campaign results 308—After the campaign is executed and completes, the Marketer 120 can upload more recent transaction data covering the time period of the campaign. The ODMS 100 then analyzes and reports how the targeted Customers 160 performed.

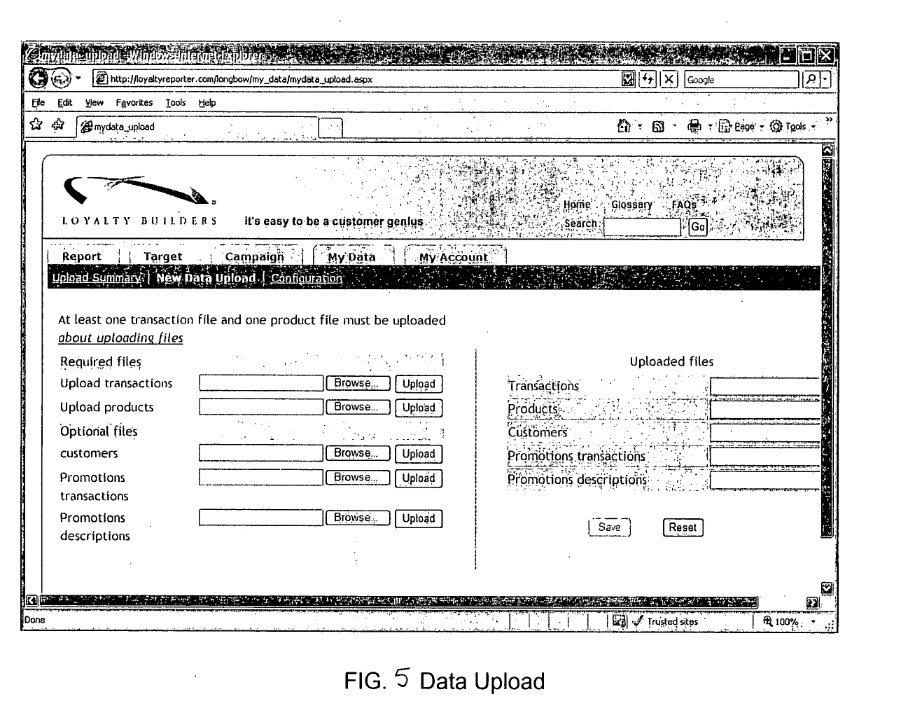

Uploading data 309—The ODMS 100 depends on data from the Marketer 120's company in order to carry out its functions. FIG. 5 shows a typical data upload screen. Four types of data are typically used:

Customer data—customer identifier(s), addresses

Transaction data—transaction date, transaction amount, customer identifier, product identifiers

Product data—product identifier(s) including SKU

Promotions data—offer identifier, offer date, Customers 160 receiving a promotion

Account management 310—Several housekeeping functions are required so that the vendor or company hosting the ODMS 100 can be paid for its efforts. Some typical housekeeping functions are:

Billing summary—This shows what has been charged to or paid by the Marketer 120.

Account information—This information allows the ODMS 100 to connect to and bill the Marketer 120.

C. Data Flows, Input and Outputs

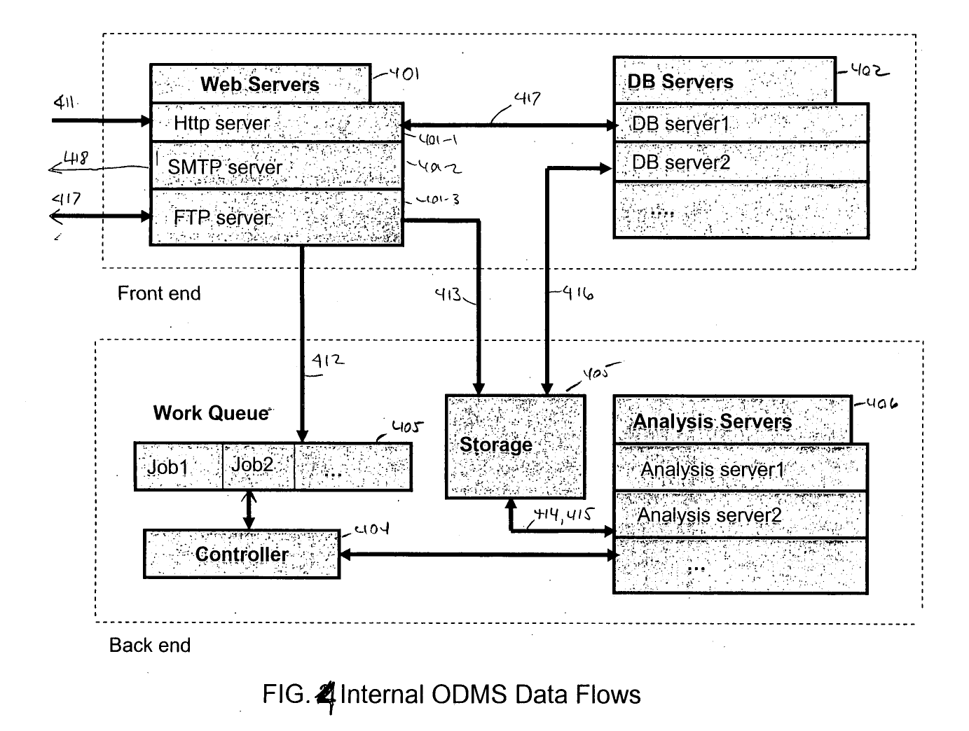

Now having some understanding of the functions it performs, the internal configuration and operation of the ODMS 100 can be better understood. The internal architecture and data flows of one embodiment of the ODMS 100 are illustrated in FIG. 4. The ODMS 100 includes front end data processing elements, such as web servers 401 (which may include HTTP server 401-1, SMTP server 401-2 and/or FTP server 401-3), and database (DB) servers 402. Back end data processing elements typically include a work queue 403, controller 404, storage 405, and analysis severs 406.

The data flows in this diagram correspond to the following process steps for one possible embodiment:

Step 411. Marketers 120 upload transaction data files as described below under Inputs.

Step 412. A job file is started in the Work Queue 405 by the Controller 404.

Step 413. Uploaded files are moved from the FTP server 401-3 into a central storage 405 location, typically embodied as a Storage Area Network (SAN).

Step 414. Upon instructions from the controller 404, one of several Analysis Servers 406 access the uploaded files in storage 405 to analyze, segment, and score the Customers 160 based on their transaction history (e.g., performing Analysis 301 as are described above).

Step 415. Analysis results are added to the input files in the central storage location 405.

Step 416. Controller 404 continues to process the job file and moves analysis results from storage 405 to one of several web-facing database servers 402.

Step 417. Marketer 120 accesses browser-based application to set filters and initiate queries that select Customers 160 to target in next campaign.

Step 418. Records of targeted Customers 160 are downloaded from the web-facing database servers 402 via SMTP server 418 into an email engine, or the print engine or through other paths into the user's local system as appropriate.

The various processing and server elements (401, 402, 404, 405, 406) of ODMS 100, as depicted in FIG. 4, can be implemented as a collection of software servers running on one or several hardware servers that are connected to the Internet. The hardware servers can be any of several standard computers with RAM, processors, and storage. The storage 405 can be internal to the hardware machines or attached via a local area network, a wide area network, or the Internet. These hardware servers will run any of several standard operating systems such as Windows Server, Unix, or Linux. The software servers running on these hardware servers are:

Http servers 401-1—Sometimes called a ‘web server’, this software uses the Hypertext Transfer Protocol to deliver web pages to users who access these pages with a browser. A typical Http server could use the Internet Information Server that is part of Windows. Code written in HTML, JavaScript, and C# handles almost all of the interaction of the ODMS 100 with the Marketer 120.

SMTP servers 401-2—Using the Simple Mail Transfer Protocol, this software is used to send email to Marketers 120 and Customers 160. In one exemplary implementation, this software is part of Windows.

FTP servers 401-3—Using the File Transfer Protocol, this software is used to accept uploads from Marketers 120, to download records back to Marketer 120s, and to send files and instructions to Printers. In one exemplary implementation, this software is part of Windows.

Database servers 402—This software is used to store and deliver records to the other servers. In one exemplary implementation, this uses code written in SQL and Microsoft SQL Server as the database manager. Other typical database managers are DB2 and Oracle.

Analysis servers 406—This piece of software uses code written in SQL to execute the algorithms that segment and score Customers 160 and calculate purchase probabilities.

Referring back to FIG. 1, Marketer 120s who use the ODMS 100 will typically use up to three components on their own data processing system (not shown in detail in the drawings):

Web browser, for example Internet Explorer or Firefox or Safari, to access the ODMS 100 via the Internet. Within the browser the Marketer 120 will create new campaigns and analyze past campaigns.

Accounting software, for example from Oracle, SAP, Microsoft, JD Edwards, Intuit, or any one of many other vendors. Typically this accounting software will have an Export function enabling the Marketer 120 to:

Extract the required customer and transaction data in comma separated variables (csv) or tab delimited or other standard formats

Upload the extracted files to the ODMS 100 using ODMS 100 facilities accessed through a browser

Downloaded files from the ODMS 100. Should the Marketer 120 elect to execute campaigns without using the email or direct mail capabilities of the ODMS 100, these files will give the Marketer 120 direct local access to the information necessary for the campaign.

Similarly, an affiliated Job Printer 140 is a separate company that prints materials for direct mail to be sent via USPS 180. The Job Printer also typically needs an FTP server to receive the necessary files from ODMS 100. In a second embodiment the Job Printer 140 may also supply a web interface for the Marketer 120 to check print proofs or make design changes to the piece to be printed.

Inputs

A first step in starting up a typical ODMS 100 is to upload transaction data into the system (Step 201 of FIG. 2). Some types of data are necessary and some are optional, used for advanced features or for a more understandable display. The file types are:

Transaction file: This is a record of who bought what, and when. It includes a transaction date, a transaction amount (which may be $0), one or more product identifiers (such as SKU or product category) and a customer identifier. There should be one record for each transaction.

Products file: This file associates a product name with an SKU or product category. Including this file facilitates using the targeting tool and makes the subsequent downloads more understandable. There should be as many records as there are current and discontinued products in the transaction data.

Customer file: For some services (for example email or direct mail) it is necessary to upload a customer file with one record per customer. This file should include email or postal address as appropriate.

Promotions Transactions file: One record is needed for each promotion offered to each customer. If a customer is offered ten promotions, then there should be ten records for that customer. Each record should include a description of the promotion matching a record in the Promotions Descriptions file.

Promotions Descriptions file: This type of file is used to describe promotions and coupons which may appear in the transaction record, with one record per promotion.

Outputs

Outputs from the system can take several forms, including but not limited to charts, tables, and data files. These outputs fall into five categories—data upload, targeting, testing, reporting, and campaigning—reflecting the several stages of the direct marketing process. Some typical outputs in each of these categories are:

Data upload

Summary of files uploaded is reported back to Marketer 120

Targeting:

Lists of campaigns with results and predictions

Upsell candidates

Cross-sell candidates

Likely buyers

At risk candidates (possible defectors)

Testing

Lists of Customers 160 for control groups and test groups for testing

Reporting

Executive overview reports such as velocity maps, revenue by decile, number of Customers 160 over time and other overviews of the company

Standard reports such as back tests showing predictability by product category, percent of Customers 160 purchasing as a function of segmentation rank,

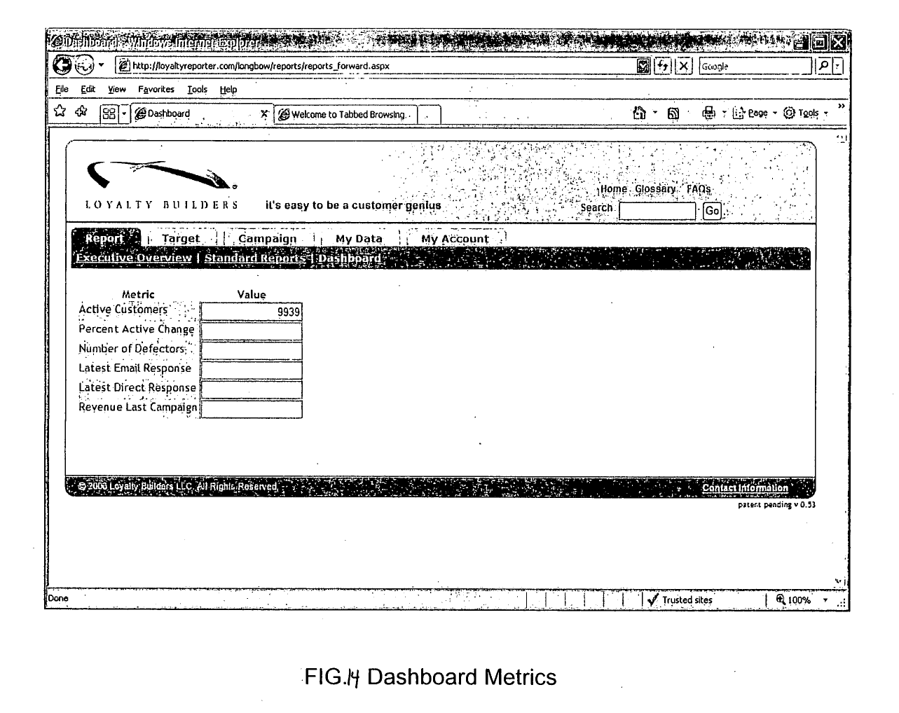

Dashboard metrics that show a snapshot summary of campaigns and customer behavior, for example as in FIG. 14.

Campaigning

Emails and reports from the email system

Print media descriptor files

Customer lists for postcard printing

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for creating marketing campaigns for a user in an integrated data processing environment comprising:
a. uploading customer transaction data from a user data processing machine to a hosting database;
b. analyzing the transaction data to provide a result that comprises at least one of predicted purchase probabilities, likely buyers, up-sell opportunities, cross-sell opportunities or potential defectors;
c. reporting the results of the analysis to the user;
d. from the results, selecting customers to target in a marketing campaign;
e. predicting at least one of anticipated response rate or revenue from the marketing campaign;
f. downloading a list of customers selected to be targeted in step (d);
g. collecting fees from the user based on the number of records downloaded in step (f).

2. The method of claim 1 additionally comprising the steps of:
h. testing the targeting and offers to be used in the campaign;
i. sending one of (i) emails to targeted customers based on the analysis results, or (ii) sending direct mail to targeted customers based on the analysis results.

3. The method of claim 2 additionally comprising the steps of:
j. uploading customer transaction data again after step (i);
k. analyzing customer transaction data resulting from the campaign; and
l. reporting a Return on Marketing Investment (ROMI).

4. The method of claim 1, wherein the step of analyzing the transaction data comprises:
h. determining a score for each customer using any one of several analytical methods including one or more of regression, RFM, genetic algorithms, or finite state machines;
i. predicting the probability of each customer in the customer population to buy each product or service in the set of products and services; and
j. segmenting the customers into groups based on their scores.

5. The method of claim 1, wherein the step of reporting the results comprises:
h. calculating a set of key performance indicators for dashboard display;
i. displaying a set of charts and graphs depicting the performance of individual customers; and
j. displaying a set of charts and graphs depicting the performance of the analyzed company as a whole.

6. The method of claim 1, wherein the step of selecting the customers to target in a marketing campaign comprises one or more of the following:
h. choosing a name for the marketing campaign;
i. choosing a type of service, where choices include up-sell, cross-sell, likely buyers; or customers at risk of defecting;
j. choosing products to sell in up-sell or cross-sell campaigns;
k. setting a purchase probability range so that targeted customers fall within the range;
l. selecting or suppressing groups of customers such as high or low ranking customers or customers in a particular marketing channel;
m. selecting or suppressing individual customers based on any or all of several other marketing metrics; and
n. setting a start date and duration for the marketing campaign so as to select customers whose metrics match the desired criteria during the campaign interval.

7. The method of claim 1, wherein the step of predicting response rate and revenue comprises:
h. using, as input data, transactions and segmentation of selected customers;
i. applying an automated response rate predictor; and
J. displaying the results in a web client.

8. The method of claim 1, wherein the step of collecting fees from users comprises:
h. setting up an account for each user;
i. collecting billing information;
j. counting the number of records downloaded in step (f);
k. multiplying the number of downloaded records by the per-record fee; and
l. charging the user's account or credit card for the download.

9. The method of claim 1, wherein the step of testing the targeting and offers comprises:
h. deciding whether to test targeting or offers;
i. selecting the experimental design (one factor at a time or multiple factors)
j. determining the size and composition of the test population in terms of their segmentation or other customer metrics;
k. suppressing one or more customers whose presence in the test population may distort results;
l. automatically subdividing the test population into various subgroups;
m. sending email or direct mail embodying the appropriate variations to subgrops members;
n. measuring the responses from each subgroup;
o. calculating the effects of the various factors using the methods in the associated patent application; and
p. displaying the results so users can select the best methods.

10. The method of claim 1, wherein the step of sending personalized emails comprises:
h. selecting email headers and sender names;
i. choosing email body copy from a set of preset or custom templates;
j. choosing the email campaign launch date; and
k. instructing an SMTP mail server to send the emails to the previously selected target customers.

11. The method of claim 1, wherein the step of sending personalized direct mail comprises:
h. choosing templates for print collateral copy; and
i. transmitting selected templates and selected customer records via an FTP server to Printing businesses for mailing.

12. The method of claim 1, wherein the step of analyzing the results of the campaign comprises:
h. calculating the actual response rate;
i. calculating the actual revenue generated by the targeted customers; and.
j. comparing the actual response rate and actual revenue with the predicted response rate and predicted revenue for the campaign.

13. The method of claim 1, wherein the step of reporting the Return on Marketing Investment comprises:
h. subtracting from the gross margin contribution of responding customers the several charges associated with selecting customers to target and generating email or direct mail to them.

14. An online system for direct marketing comprising:
a. set of web servers that function to manage a direct marketing system, including handling messaging, and exchanging data files with Marketers, and the customers of Marketers;
b. set of database servers that function to manage transaction data and predictive analytics results for clients of the system;
c. set of analysis servers that function to analyze transaction data and predict purchase probabilities;
d. a central data store that functions to serve data to the various processing units of the system;
e. a job queue that functions to organize and prioritize a set of tasks necessary to operate the system; and
f. a controller that executes tasks in the job queue.

15. The system of claim 14, wherein the web servers include at least one of an HTTP server; FTP server; or SMTP server.

16. The system of claim 14, wherein the HTTP server manages a set of expert systems and wizards to plan, set up, and execute marketing campaigns.

17. The system of claim 14, wherein the FTP server manages external data transfers.

18. The system of claim 14, wherein the SMTP server manages email messaging.

19. The system of claim 14, wherein at least some of the analyses and data transfers are performed against a set of data stored in the central storage facility.

20. The system of claim 14, wherein the set of database servers includes an Administrative Database.

21. The system of claim 20, wherein the Administrative Database manages payment information and associated user privileges.

22. The system of claim 14, wherein the analysis servers execute code written in SQL to perform various functions which may include, among others, predicting customer behavior, identifying potential defectors, identifying likely buyers, identifying up-sell candidates, identifying cross-sell candidates, and calculating purchase probabilities.
